(19) United States
(12) Patent Application Publication
(10) Pub. No.: US 2026/0312868 A1
(43) Pub. Date: Oct. 8, 2026

(54) METHOD OF ADVANCED MODEL ADAPTATION FOR RADIO ACCESS NETWORK

(71) Applicant: AUMOVIO Germany GmbH, Frankfurt am Main (DE)

(72) Inventors: Hojin KIM, Regensburg, Bavaria (Bayern) (DE); Rikin SHAH, Langen, Hessen (DE)

(73) Assignee: AUMOVIO Germany GmbH, Frankfurt am Main (DE)

(21) Appl. No.: 19/482,899

(22) PCT Filed: May 7, 2024
(86) PCT No.: PCT/EP2024/062499

§ 371 Date: Nov. 10, 2025

(30) Foreign Application Priority Data
May 11, 2023 (DE) 10 2023 204 390.4

(51) Int. Cl. H04L 41/0816; H04L 41/16; H04L 43/16

(52) U.S. Cl. CPC H04L 41/0816; H04L 41/16; H04L 43/16

(57) ABSTRACT

The present disclosure describes methods of model adaptation/switching for AI/ML based model in wireless mobile communication system including base station (e.g., gNB) and mobile station (e.g., UE). Threshold-based mapping relationship is configured to enable model adaptation using triggering information depending on dynamic changes of model operation environment at device side.

### CROSS REFERENCE TO RELATED APPLICATIONS

This application is the U.S. National Phase Application of PCT International Application No. PCT/EP2024/062499, filed May 7, 2024, which claims priority to German Patent Application No. 10 2023 204 390.4, filed May 11, 2023, the contents of such applications being incorporated by reference herein.

### FIELD OF THE INVENTION

The present disclosure relates to AI/ML based model adaptation, where techniques for pre-configuring and signaling the specific information about mapping relationship information using association between models and other index values for the model adaptation are presented.

### BACKGROUND OF THE INVENTION

In 3GPP, one of the selected study items as the approved Release 18 package is AI/ML (artificial intelligence/machine learning) as described in the related document (RP- 213599) addressed in 3GPP TSG RAN meeting #94e, incorporated herein by reference. The official title of AI/ML study item is “Study on AI/ML for NR Air Interface”, incorporated herein by reference, and currently RAN WG1 and WG2 are actively working on specification. The goal of this study item is to identify a common AI/ML framework and areas of obtaining gains using AI/ML based techniques with use cases.

According to 3GPP, the main objective of this study item is to study AI/ML framework for air-interface with target use cases by considering performance, complexity, and potential specification impact. In particular, AI/ML model, terminology and description to identify common and specific characteristics for framework will be one of key work scope. Regarding AI/ML framework, various aspects are under consideration for investigation and one of key items is about lifecycle management of AI/ML model where multiple stages are included as mandatory for model training, model deployment, model inference, model monitoring, model updating etc.

Earlier, in 3GPP TR 37.817 for Release 17, titled as Study on enhancement for Data Collection for NR and EN-DC, incorporated herein by reference, UE mobility was also considered as one of AI/ML use cases and one of scenarios for model training/inference is that both functions are located within RAN node. Followingly, in Release 18 the new work item of “Artificial Intelligence (AI)/Machine Learning (ML) for NG-RAN”, incorporated herein by reference, was initiated to specify data collection enhancements and signaling support within existing NG-RAN interfaces and architecture.

For the above active standardization works, currently there is no specification defined for signaling methods or gNB-UE behaviors about supporting AI/ML model adaptation or model switching. Using the mismatched model on both sides or single side might result in model performance degradation when the activated model cannot run properly on UE with the available resource. Based on the above, it is observed that model transfer signaling for model adaptation/switching by network side can be quite increased so as to adapt to different dynamic conditions associated with UE capability changes. Due to this, the applicable model(s) at UE can be unmatched with the reported UE capability as there is delay with legacy UE capability report.

EP3543917A1, incorporated herein by reference, describes the use of low-precision methods (i.e., methods that use low-precision weights) to train deep neural networks (DNNs).

WO2020234902A1, incorporated herein by reference, describes a radio mapping architecture for applying Machine Learning techniques to wireless radio access networks.

WO2022033804A1, incorporated herein by reference, describes splitting an AI/ML model into a plurality of sub-parts and forming a set of aggregation chunks.

US20090170552A1, incorporated herein by reference, describes a switching profile method for mobile device with detection of predetermined condition.

### SUMMARY OF THE INVENTION

The described problem is solved the embodiments of his application. The first aspect is a method of advanced model adaptation for radio access network of generating the pre-configured mapping relationship between applicable sub-model IDs with different threshold values, comprising, threshold values are pre-defined to match with activation triggering of different AI/ML sub-models, sub-model IDs are split from the common model ID, where sub-models can have lower model complexity/size compared with common model ID, the attribute data for threshold value calculation, {UE device resource specification, model configuration, site/scenario, application}, can be defined for different use case/application and implementation-specific environment together with considering UE capability, the listed sub-models can be dynamically configured with the pre-defined parameter set change information sent from network where the determined model ID can be macro model and the listed multiple sub-models can be micro models so that macro model is full featured model with highest complexity/size while micro model is partially featured model with lower complexity/size, depending on practical use case, the determined model ID itself can be one of the indexed sub-model, the size of mapping table or number of sub-models can be adapted to the specific model operation applications and/or environment.

In some embodiments of the method according to the first aspect, the method is characterized by, that the UE monitors model operation and device resource status supporting it together so that the pre-configured threshold value is detected for triggering and when triggering is enabled with specific threshold value, the current model in operation is then switched to the associated sub-model with the matched threshold value autonomously.

In some embodiments of the method according to the first aspect, the method is characterized by, that the network side provides the mapping relationship and triggering information with the associated configuration, comprising, threshold values are defined/generated based on attribute data, {UE device resource specification, model configuration, site/scenario, application}, different number of mapping relationships and triggering information can be formed for different use case/application and implementation-specific environment together with considering UE capability.

In some embodiments of the method according to the second aspect, the method is characterized by that is a method of forming full model (fML) and partial models (pML) for radio access network, comprising, network generates two model categories such that fML is the original model having full feature set and pML is the simplified model having lower complexity and/or smaller feature set for applying any specific model(s) to UE. fML and pML are pre-configured so that model complexity is lower and feature set size is smaller for partial models where model configuration parameters such as number of layers and feature input can be adjusted to determine a finite set of full-/partial-models. Selection of models from fML and pMLs depends on UE ML capacity status to match with target model operation so that any pMLs can be run on the reduced available resource at UE device. Scalable model structure supports models with different complexity levels by using parameter configuration.

In some embodiments of the method according to the first and the second aspect, the method is characterized by different number of UE groups can be configured to operate the matched model(s) with the reported UE ML capability information.

According to a third aspect, the present disclosure relates to an apparatus for Method of advanced model adaptation for radio access network of generating the pre-configured mapping relationship between applicable sub-model IDs with different threshold values and of forming full model (fML) and partial models (pML) the apparatus comprising a wireless transceiver, a processor coupled with a memory in which computer program instructions are stored, said instructions being configured to implement steps of first and the second aspect.

According to a fourth aspect, the present disclosure relates to a user Equipment comprising an apparatus according to any one of the embodiments of the first and the second aspect.

According to a fifth aspect, the present disclosure relates to a base station user Equipment comprising an apparatus according to any one of the embodiments of the first and the second aspect.

According to a six aspect, the present disclosure relates to a wireless communication system, wherein the base-station (gNB) comprises a processor coupled with a memory in which computer program instructions are stored, said instructions being configured to implement steps of first and the second aspect, and wherein the user equipment (UE) comprises a processor coupled with a memory in which computer program instructions are stored, said instructions being configured to implement steps of first and the second aspect.

### BRIEF DESCRIPTION OF THE DRAWINGS

FIG. 1 is an exemplary table of threshold-based mapping relationship.

FIG. 2 is an exemplary signaling of autonomous sub-model switching by UE.

FIG. 3 is a flow chart of mapping relationship configuration with triggering information by network side.

FIG. 4 is a flow chart of processing autonomous sub-model switching by UE.

FIG. 5 is an exemplary block diagram of using full-/partial-models.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate.

Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise.

The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (loT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

The following explanation will provide the detailed description of the mechanism about pre-configuring and signaling the specific information about mapping relationship information using association between models and other index values for dataset information. AI/ML based techniques are currently applied to many different applications and 3GPP also started to work on its technical investigation to apply to multiple use cases based on the observed potential gains. AI/ML lifecycle can be split into several stages such as data collection/pre-processing, model training, model testing/validation, model deployment/update, model monitoring, model switching/selection etc., where each stage is equally important to achieve target performance with any specific model(s).

In applying AI/ML model for any use case or application, one of the challenging issues is to manage the lifecycle of AI/ML model. It is mainly because the data/model drift occurs during model deployment/inference and it results in performance degradation of AI/ML model. Fundamentally, the dataset statistical changes occur after model is deployed and model inference capability is also impacted with unseen data as input. In a similar aspect, the statistical property of dataset and the relationship between input and output for the trained model can be changed with drift occurrence.

When AI/ML model enabled wireless communication network is deployed, it is then important to consider how to handle AI/ML model/dataset transfer under operations such as model training, inference, monitoring, updating, etc. When AI/ML model is transferred to UE, the transferred model cannot be fully operated if model size and/or complexity is higher than ML capability supported by UE. For example, there are many different levels of ML capabilities for each UEs. The common model to be transferred can work well for some UEs and not for other UEs if minimum ML capability is not guaranteed for all UEs due to the limited device resource such as compute power/memory size/battery power consumption etc. ML support capability at UE can be dynamically changed because applicable conditions such as scenarios/sites for any specific model/functionality are not static, but dynamic. Therefore, when UE ML capability is dynamic, the configured model operation with specific functionality can be unstable along with performance quality degradation depending on UE ML capability status change. Model transfer signaling by network side can be quite increased so as to adapt to different dynamic conditions associated with UE capability changes. Due to this, the applicable model(s) at UE can be unmatched with the reported UE capability as there is delay with legacy UE capability report.

As a new mechanism to resolve this issue, the threshold-based mapping relationship between applicable sub-model IDs with different threshold values is pre-configured/provided by network side. For example, when a threshold value is triggered at UE during model operation, UE can autonomously switch between the pre-configured sub-models that is matched with the indicated threshold value. The threshold-based mapping relationship with triggering configuration information is sent through system information or RRC signaling.

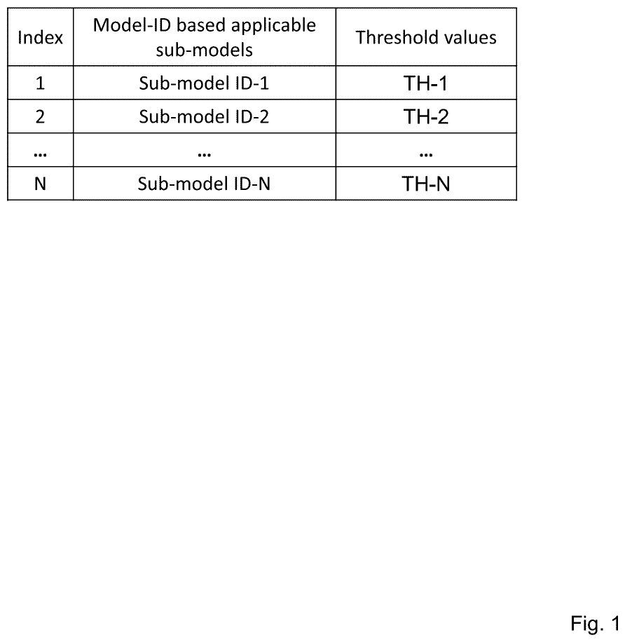

FIG. 1 shows an exemplary table of threshold-based mapping relationship. In this table, threshold values are pre-defined to match with activation triggering of different AI/ML sub-models. Sub-model IDs are split from the common model ID, where sub-models can have lower model complexity/size compared with common model ID. Threshold values are pre-configured to reflect available resource of UE capability to run a model where each indexed sub-models can be properly performed based on the available UE capability resource according to indication of threshold values. Threshold values (e.g., derived from using attribute data, {UE device resource specification, model configuration, site/scenario, application}) can be defined for different use case/application and implementation-specific environment together with considering UE capability such as compute power, memory size, and battery power level, etc. where the common or standardized capability requirements to run models can be used to threshold value calculation although there are varying types of devices with model support capabilities. Depending on different applicable conditions, this threshold-based mapping relationship need to be updated and sent to UE (e.g., through RRC signaling).

Based on the determined model ID for use, the listed sub-models can be dynamically configured with the pre-defined parameter set change information sent from network where the determined model ID can be macro model and the listed multiple sub-models can be micro models so that macro model is full featured model with highest complexity/size while micro model is partially featured model with lower complexity/size. However, depending on practical use case, the determined model ID itself can be one of the indexed sub-model. Therefore, any separate model transfers of each sub-models are not needed where any sub-models can be dynamically switched at UE side based on the pre-defined parameter set change information. The size of mapping table or number of sub-models can be adapted to the specific model operation applications and/or environment.

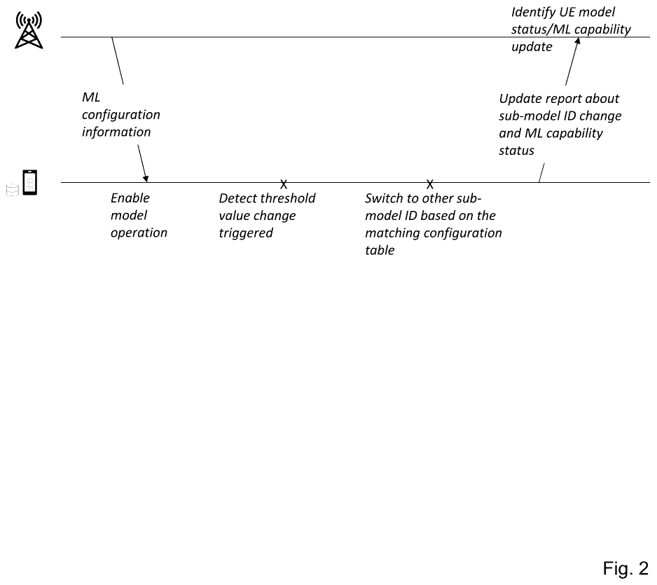

FIG. 2 shows an exemplary signaling of autonomous sub-model switching by UE.

Without receiving model switching/adaptation indication from network side, UE can autonomously switch/adapt models based on mapping table and the pre-configuration information about sub-models with triggering rule. After sub-model switching/adaptation, UE sends ML capability status and model switching updates. This example is based on event-triggered method for model switching/adaptation.

However, using the pre-configured sub-models periodically model switching/adaptation can be made as well.

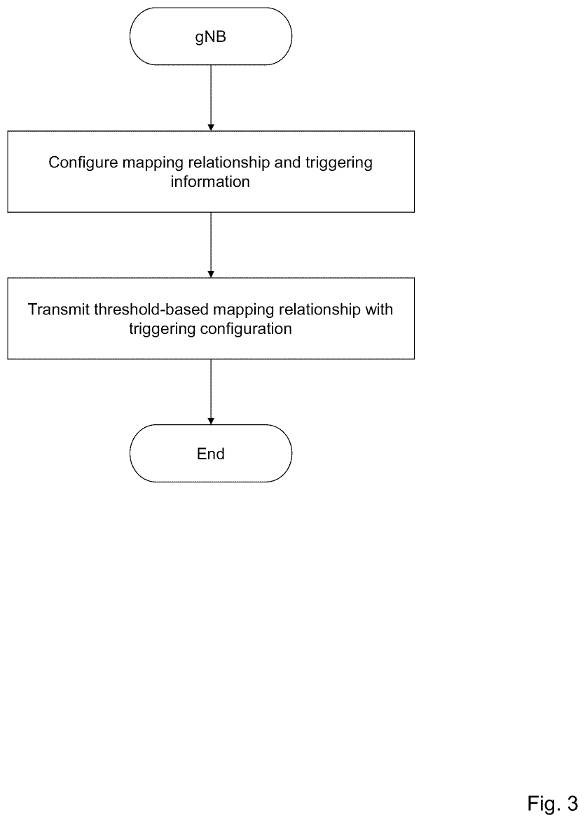

FIG. 3 shows a flow chart of mapping relationship configuration with triggering information by network side. On network side, the mapping relationship and triggering information are configured together. Threshold values are pre-defined to match with activation triggering values of different AI/ML sub-models. Threshold values are pre-configured to reflect available resource of UE capability to run a model where each indexed sub-models can be properly performed based on the available UE capability resource according to indication of threshold values. Threshold values (e.g., derived from using attribute data, {UE device resource specification, model configuration, site/scenario, application}) can be defined for different use case/application and implementation-specific environment together with considering UE capability.

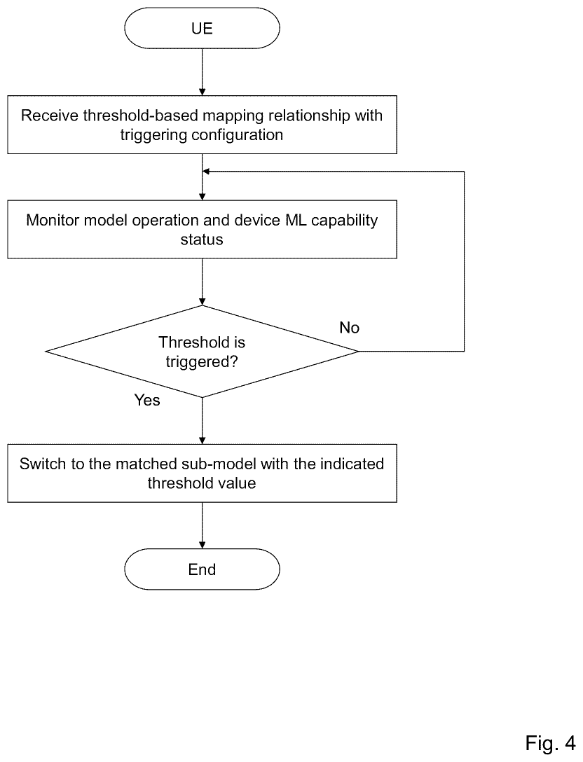

FIG. 4 shows a flow chart of processing autonomous sub-model switching by UE. After receiving mapping relationship configuration with triggering information, UE monitors model operation and device resource status supporting it together so that the pre-configured threshold value is detected for triggering. When triggering is enabled with specific threshold value, the current model in operation is then switched to the associated sub-model with the matched threshold value.

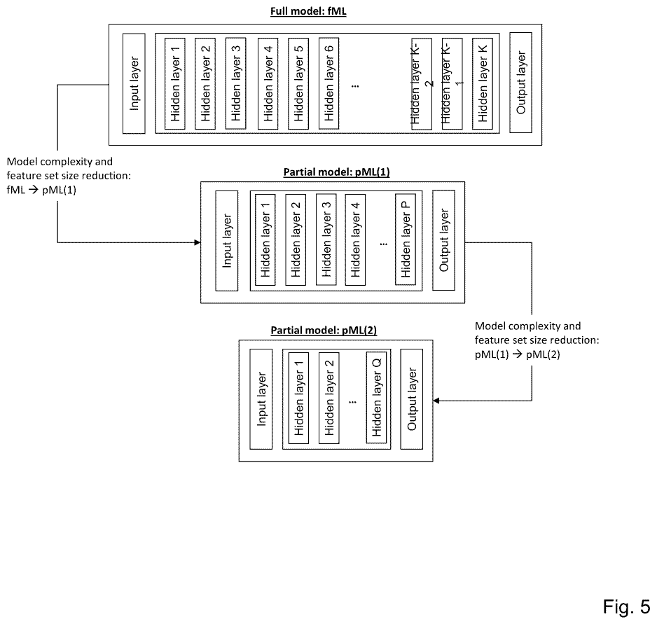

FIG. 5 shows an exemplary block diagram of using full-/partial-models. In this example, there are one full model (fML) and two partial models (pML). When applying any specific model(s) to UE, network generates two model categories such that fML is the original model having full feature set and pML is the simplified model having lower complexity and/or smaller feature set. Therefore, the key differences between fML and pML are that model complexity is lower and feature set size is smaller for partial models where model configuration parameters such as number of layers and feature input can be adjusted to determine a finite set of full-/partial-models. Selection of models from fML and pMLs depend on UE ML capacity status to match with target model operation so that any pMLs can be run on the reduced available resource at UE device. Scalable model structure then supports models with different complexity levels by using parameter configuration in this example. Based on the reported UE ML capability information, two or more groups of UEs can be also determined such as UE group #1 that can support full model transfer and UE group #2 that can support partial model transfer that are matched with the reported UE ML capability information. Number of UE groups can be configurable. Therefore, UE grouping-based model adaptation can be applicable based on scalable model set.

### Abbreviations

BWP Bandwidth part
CBG Code block group
CLI Cross Link Interference
CP Cyclic prefix
CQI Channel quality indicator
CPU CSI processing unit
CRB Common resource block
CRC Cyclic redundancy check
CRI CSI-RS Resource Indicator
CSI Channel state information
CSI-RS Channel state information reference signal
CSI-RSRP CSI reference signal received power
CSI-RSRQ CSI reference signal received quality
CSI-SINR CSI signal-to-noise and interference ratio
CW Codeword
DCI Downlink control information
DL Downlink
DM-RS Demodulation reference signals
DRX Discontinuous Reception
EPRE Energy per resource element
IAB-MT Integrated Access and Backhaul-Mobile Terminal
L1-RSRP Layer 1 reference signal received power
LI Layer Indicator
MCS Modulation and coding scheme
PDCCH Physical downlink control channel
PDSCH Physical downlink shared channel
PSS Primary Synchronisation signal
PUCCH Physical uplink control channel
QCL Quasi co-location
PMI Precoding Matrix Indicator
PRB Physical resource block
PRG Precoding resource block group
PRS Positioning reference signal
PT-RS Phase-tracking reference signal
RB Resource block
RBG Resource block group
RI Rank Indicator
RIV Resource indicator value
RS Reference signal
SCI Sidelink control information
SLIV Start and length indicator value
SR Scheduling Request
SRS Sounding reference signal
SS Synchronisation signal
SSS Secondary Synchronisation signal
SS-RSRP SS reference signal received power
SS-RSRQ SS reference signal received quality
SS-SINR SS signal-to-noise and interference ratio
TB Transport Block
TCI Transmission Configuration Indicator
TDM Time division multiplexing
UE User equipment
UL Uplink

1. A method of advanced model adaptation for radio access network by generating the pre-configured mapping relationship between applicable sub-model IDs with different threshold values, comprising:
Threshold values are pre-defined to match with activation triggering of different AI/ML sub-models;
Sub-model IDs are split from the common model ID, where sub-models can have lower model complexity/size compared with common model ID;
The attribute data for threshold value calculation, {UE device resource specification, model configuration, site/scenario, application}, can be defined for different use case/application and implementation-specific environment together with considering UE capability;
The listed sub-models can be dynamically configured with the pre-defined parameter set change information sent from network where the determined model ID can be macro model and the listed multiple sub-models can be micro models so that macro model is full featured model with highest complexity/size while micro model is partially featured model with lower complexity/size;
Depending on practical use case, the determined model ID itself can be one of the indexed sub-model;
The size of mapping table or number of sub-models can be adapted to the specific model operation applications and/or environment.

2. The method according to any previous claim 1, wherein UE monitors model operation and device resource status supporting it together so that the pre-configured threshold value is detected for triggering and when triggering is enabled with specific threshold value, the current model in operation is then switched to the associated sub-model with the matched threshold value autonomously.

3. The method according to claim 1, wherein network side provides the mapping relationship and triggering information with the associated configuration, comprising:
Threshold values are defined/generated based on attribute data, {UE device resource specification, model configuration, site/scenario, application},
Different number of mapping relationships and triggering information can be formed for different use case/application and implementation-specific environment together with considering UE capability.

4. A method of forming full model (fML) and partial models (pML) for radio access network, comprising:
Network generates two model categories such that fML is the original model having full feature set and pML is the simplified model having lower complexity and/or smaller feature set for applying any specific model(s) to UE;
fML and pML are pre-configured so that model complexity is lower and feature set size is smaller for partial models where model configuration parameters such as number of layers and feature input can be adjusted to determine a finite set of full-/partial-models;
Selection of models from fML and pMLs depends on UE ML capacity status to match with target model operation so that any pMLs can be run on the reduced available resource at UE device;
Scalable model structure supports models with different complexity levels by using parameter configuration.

5. The method according to claim 1, wherein different number of UE groups can be configured to operate the matched model(s) with the reported UE ML capability information.

6. Apparatus for generating the pre-configured mapping relationship between applicable sub-model IDs with different threshold values the apparatus comprising a wireless transceiver, a processor coupled with a memory in which computer program instructions are stored, said instructions being configured to implement the method of claim 1

7. A User Equipment comprising an apparatus according to claim 6.

8. A Base station comprising an apparatus according to claim 6.

9. A Wireless communication system, wherein the gNB comprises a processor coupled with a memory in which computer program instructions are stored, and
wherein the user equipment (UE) comprises a processor coupled with a memory in which computer program instructions are stored,
wherein said instructions of each of the gNB processor and the UE processor are configured to implement steps of claim 1.
